(19) United States
(12) Patent Application Publication
(10) Pub. No.: US 2014/0224413 A1
(43) Pub. Date: Aug. 14, 2014

(54) Tape dispenser with integrated paper cutter

(71) Applicant: Adam Matthew Tullos, Conway, AR (US)

(72) Inventor: Adam Matthew Tullos, Conway, AR (US)

(21) Appl. No.: 14/172,665

(22) Filed: Feb. 4, 2014

Related U.S. Application Data
(60) Provisional application No. 61/764,569, filed on Feb. 14, 2013.

(51) Int. Cl. B29C 65/50; B32B 38/00

(52) U.S. Cl. CPC B29C 65/50; B32B 38/0004
USPC 156/227; 156/517; 156/256

(57) ABSTRACT

An apparatus is disclosed which includes a tape dispenser that bears a roll of tape on a cylindrical hub fused to at least one longitudinal wall, in turn fused to an outer wall that parallels the cylindrical hub's walls, and that extends to the right to form an arm bearing a serrated blade for cutting tape. The underside bears a paper cutting device made up of rectangular groove with angled blade that extends below it to a guiding lip, which may be slid beneath a sheet of paper such that the paper slides over the blade, which cuts the paper.

### RELATED APPLICATION DATA

This application claims the benefit of Provisional Application No. 61/764,569 filed on Feb. 14, 2013.

### TECHNICAL FIELD

This invention relates generally to tape dispensers, and specifically to tape dispensers combined with other tools.

### BACKGROUND ART

Tape dispensers have been around almost as long as there has been adhesive tape. Their reason for existence is convenience: they provide a way to apply tape quickly and easily, and to cut the tape when the appropriate length has been reached. Virtually all modern tape dispensers possess some kind of a roller to allow the roll of tape to rotate freely as the tape is dispensed, some way to secure the end of the tape to avoid the effort of repeatedly searching for it on the roll, and some kind of cutting edge positioned in such a way as to cut the tape easily once dispensed, at minimal risk to the person using the tape dispenser.

One of the best known home uses for tape dispensers is gift-wrapping, where a sheet of wrapping paper is cut down to an appropriate size, wrapped around a gift, and secured in place with a piece of tape, usually of the transparent cellophane variety. As a result, a few designs have been invented that incorporate a tape dispenser into combination product that aims to make the gift-wrapping process easier. Some such designs involve a cutting tool that can be stored in a desktop style tape dispenser. Others combine tape dispensers with dispensers of wrapping paper, or tabletop boards for measuring and cutting wrapping paper stowed beside them. The existing designs, however, tend to be bulky and unwieldy compared to the disposable tape dispensers found in stores around the world. Moreover, the presence of multiple detachable parts in many of the designs increases the likelihood that one or more parts will be misplaced. Finally, the combination tape dispensers currently existent for gift-wrapping purposes are not amenable to mass production of disposable models, and as a result are unlikely be desirable to a consumer who only needs them sporadically for use on special occasions.

### SUMMARY OF THE EMBODIMENTS

It is therefore an object of this invention to create a lightweight, safe, user-friendly combination tape dispenser and paper cutter. It is a further object of this invention to create a combination tape dispenser and paper cutter that is effective and inexpensive to produce. It is a further object still of this invention to provide consumers with a convenient and inexpensive tool to aid in gift-wrapping presents. It is a yet further object of this invention to provide a lower-cost alternative to purchasing a tape dispenser and a pair of scissors, and an alternative that involves fewer separate objects that can be misplaced.

A device is disclosed for cutting paper and dispensing tape. The device includes a substantially cylindrical hub about which a roll of tape is rotably mounted, at least one transverse wall fixed to a circular end of the hub, and an outer wall fixed to the transverse wall, having at least one substantially flat portion and forming, with the transverse wall and hub, a partially enclosed annular chamber for housing the roll of tape. The device also includes a slide cutter that includes (i) a small opening in the substantially flat portion of the outer wall, (ii) a blade protruding from the small opening, the blade having a proximal end within the small opening, a distal end outside the small opening, and an edge, the edge forming an acute angle with the substantially flat portion, and (iii) a guiding lip at the distal end of the blade and substantially parallel to the substantially flat portion.

A related embodiment of the device includes two substantially parallel ridges extending from the substantially flat portion, the ridges forming a rectangular groove such that the slide cutter is within the rectangular groove. An additional embodiment includes a set of graduated demarcations along at least one of the two ridges. In yet another embodiment, the device has a creasing fin fixed to the outer wall. The guiding lip has a pointed end, in another embodiment.

A method is also disclosed for cutting paper, involving providing a device as described above, slipping the guiding lip under an edge of a sheet of paper, and sliding the device horizontally, forcing the paper over the blade. In a related embodiment, the method involves folding the paper around an object, dispensing tape from the device, and using the dispensed tape to secure the paper as folded.

Also claimed is a device for dispensing tape and cutting paper. The device includes a body having a front end, a back end, a top, a bottom having a substantially flat portion, and at least one transverse wall, a substantially cylindrical hub around which a roll of tape is rotably mounted, and having at least one circular end fixed to the at least one transverse wall, such that the hub, top, bottom, back end, and front end together form a partially open annular chamber enclosing the roll of tape, and a slide cutter including (i) an opening in the substantially flat portion of the bottom, (ii) a housing, having a proximal end inside of the small opening and a distal end outside of the small opening, a blade set in the housing, having an edge facing the front end of the device, the edge forming an acute angle with the plane of the substantially flat portion of the underside, and a guiding lip, fixed to the distal end of the housing, the guiding lip substantially parallel to the substantially flat portion of the underside and having an end that extends past the edge of the blade toward the front end.

In some embodiments, the bottom also includes a curved portion that curves upward from the substantially flat portion, and the guiding lip protrudes beyond the curvature of the curved portion. In another embodiment, the underside of the guiding lip is substantially flat. In an additional embodiment, the underside also includes two parallel ridges running from the front end to the back end on opposite sites of the substantially flat portion and forming a rectangular groove that contains the slide cutter. In yet another embodiment, the annular chamber extends away from the hub toward the front end to form a hollow arm that bears a serrated edge for cutting lengths of dispensed tape. According to still another embodiment, the hollow arm further includes a flat section behind the serrated edge, for adhering the end of the tape. Another embodiment includes at least one ergonomic indentation in the at least one transverse wall.

Other aspects, embodiments and features of the device and method will become apparent from the following detailed description thereof when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment is shown where illustration is not necessary to allow those of ordinary skill in the art to understand the disclosed embodiments.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1A is a view of an embodiment of the disclosed device as seen along the axis of the cylindrical tape-bearing hub;

FIG. 1B is a perspective view of an embodiment of the disclosed device showing the underside;

FIG. 2 is a flow chart illustrating an embodiment of the disclosed method;

FIG. 3A is a perspective view showing an embodiment of the disclosed device cutting a sheet of paper, as seen from beneath the sheet of paper.

FIG. 3B is a transverse cross-sectional view of an embodiment of the device in the act of cutting a sheet of paper using the paper-cutting apparatus.

### DETAILED DESCRIPTION OF SPECIFIC EMBODIMENTS

An embodiment of the disclosed device is a tape dispenser with an integrated paper cutter that can be operated by holding the tape dispenser in one hand and sliding it across a sheet of paper, such as gift wrapping paper, to slice off a section of the desired size and shape. A user can place the gift to be wrapped on a large piece of wrapping paper, cut the piece of paper to an appropriate size and shape, fold the paper over the gift, and tape the paper in place, using no equipment but the device. It is lightweight, safe, and inexpensive, and could be sold anywhere tape or wrapping paper are available, particularly around the holiday season.

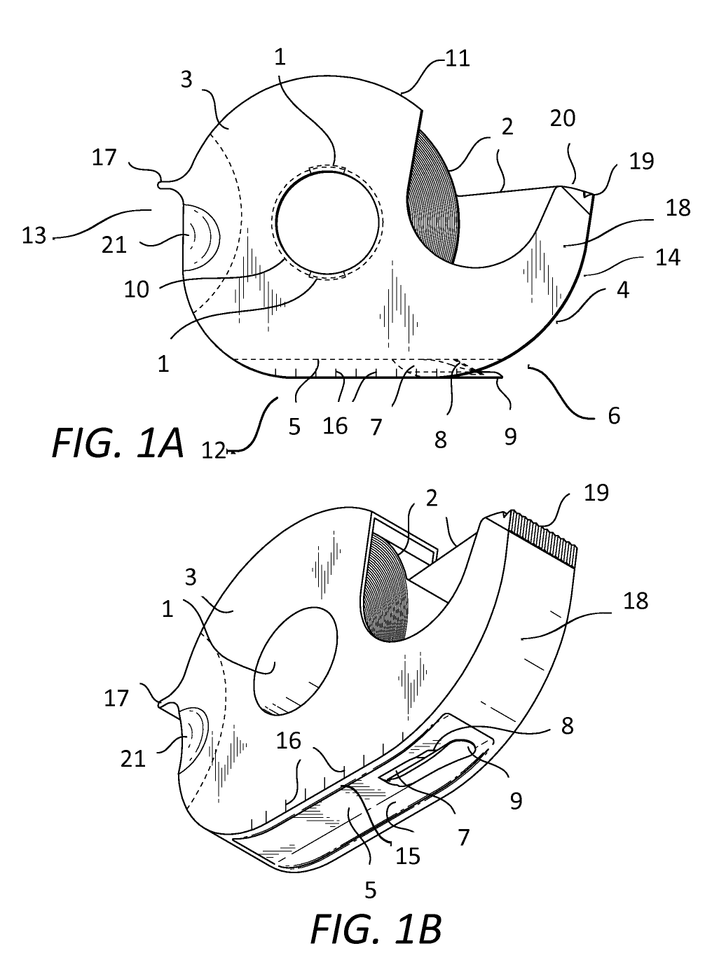

FIGS. 1A and 1B illustrate an embodiment of the disclosed device for cutting paper and dispensing tape. In one embodiment, the device includes a substantially cylindrical hub 1 about which a roll of tape 2 is rotably mounted, at least one transverse wall 3 fixed to a circular end of the hub 1, an outer wall 4 fixed to the transverse wall, having at least one substantially flat portion 5 and forming, with the transverse wall 3 and hub 1, a partially enclosed annular chamber for housing the roll of tape 2, and a slide cutter 6 including (i) a small opening 7 in the substantially flat portion 5 of the outer wall 4, (ii) a blade 8 protruding from the small opening, the blade 8 having a proximal end within the small opening 7, a distal end outside the small opening 7, and an edge, the edge forming an acute angle with the substantially flat portion 5, and (iii) a guiding lip 9 at the distal end of the blade 8 and substantially parallel to the substantially flat portion 5.

In some embodiments, the cylindrical hub 1 has a radius slightly less than the interior radius 10 of the roll of tape 2 to be borne on the hub 1, so that the roll of tape 2 thus borne can rotate freely about the hub 1 with its motion in other directions more or less restricted. At least one end of the hub 1 is fixed to at least one transverse wall 3. The hub 1 may be attached to the at least one transverse wall 3. The hub 1 may be fused to the at least one transverse wall 3. The at least one transverse wall 3 and the hub 1 may form a single monolithic unit. If there is only one transverse wall 3, the end of the hub 1 opposite it may be flanged or bear other means to prevent the tape 2 from sliding off of the hub 1. The at least one transverse wall 3 is fixed to an outer wall 4 having at least one substantially flat portion. In some embodiments, the outer wall 4 curves around so that the outer wall 4, transverse wall 3, and hub 1 form an annular chamber enclosing the roll of tape 1. In some embodiments, the outer wall 4 describes a top 11, bottom 12, back end 13, and front end 14 for the device. In some embodiments, the substantially flat portion 5 of the outer wall 4 is located on the bottom 12. The top 11, bottom 12, back end 13, front end 14, the at least one transverse wall 3 and the hub 1 together form the body of the device. The body of the device may be made of any material known to persons of ordinary skill in the art to be suitable for creating appliances, including without limitation various kinds of plastic or similar rigid polymer materials, metal, natural and synthetic resins, wood, or fiberglass.

In some embodiments, the device also includes two substantially parallel ridges 15 extending from the substantially flat portion 5, the ridges forming a rectangular groove such that the slide cutter is within the rectangular groove. The ridges may be attached to the outer wall 4. The ridges may be fused to the outer wall 4. The ridges 15 and the outer wall 4 may form a single, monolithic unit. The edges of the ridges 15 may describe a substantially horizontal line; where the substantially flat portion 5 is located on the bottom 12, the ridges 15 may be so formed that the device can rest stably on the ridges when set on its bottom 12. Some embodiments of the device further include a set of graduated demarcations 16 along at least one of the two ridges 15; the graduated demarcations may be used to measure lengths, for instance to gauge the length of a gift to be wrapped, and to measure out the appropriate amount of gift-wrapping paper to be cut, using the paper cutting apparatus, to wrap a gift. Some embodiments of the device further include a creasing fin 17 fixed to the outer wall 4. In one embodiment, the creasing fin 17 is a ridge that may be used to curl ribbons, to crease folded edges of paper or tape, or to flatten dispensed tape against an object to further guarantee strong adhesion. In some embodiments, the creasing fin 17 is attached to the outer wall 4. In some embodiments, the creasing fin 17 is fused to the outer wall 4. In other embodiments, the creasing fin 17 and the outer wall 4 form a single, monolithic unit.

In some embodiments, the annular chamber extends away from the hub 1 toward the front end 14 of the device to form a hollow arm 18 that bears a serrated edge 19 for cutting lengths of dispensed tape 2. The hollow arm may also include a flat section 20 behind the serrated edge 19, for adhering the end of the tape 2; for instance, the end of the tape 2 may be kept adhered to the flat section 20 so that a person using it may easily retrieve the end of the tape 2 when needed. In some embodiments, the device also includes at least one ergonomic indentation 21. The ergonomic indentation 21 may be formed to admit the curvature of the finger or thumb of a typical person, making it easier to grip the device. In some embodiments, the at least one ergonomic indentation 21 is located near the back 13 of the device. In some embodiments, the at least one ergonomic indentation is in the transverse wall 3 of the device.

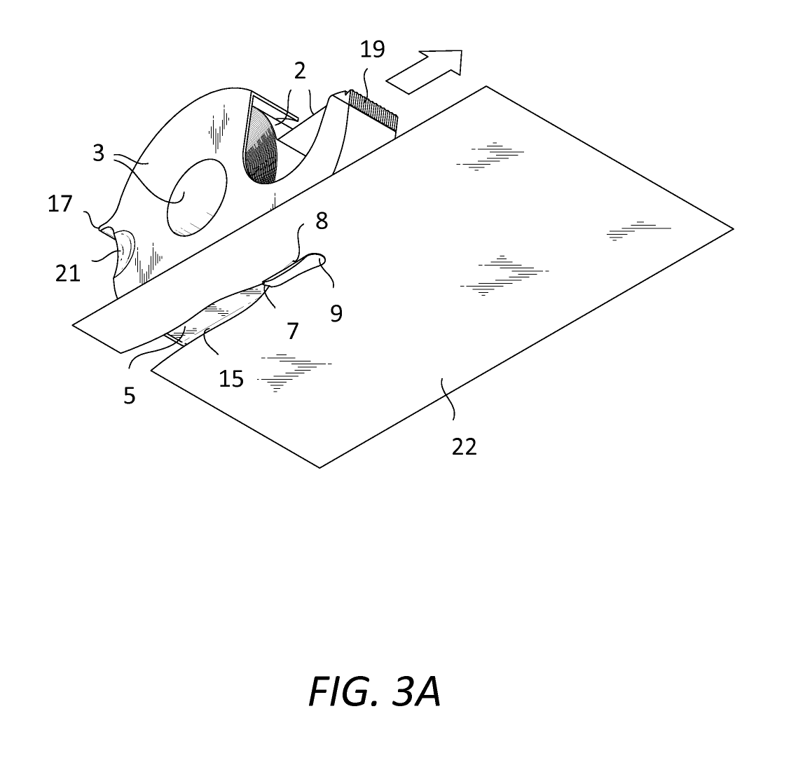

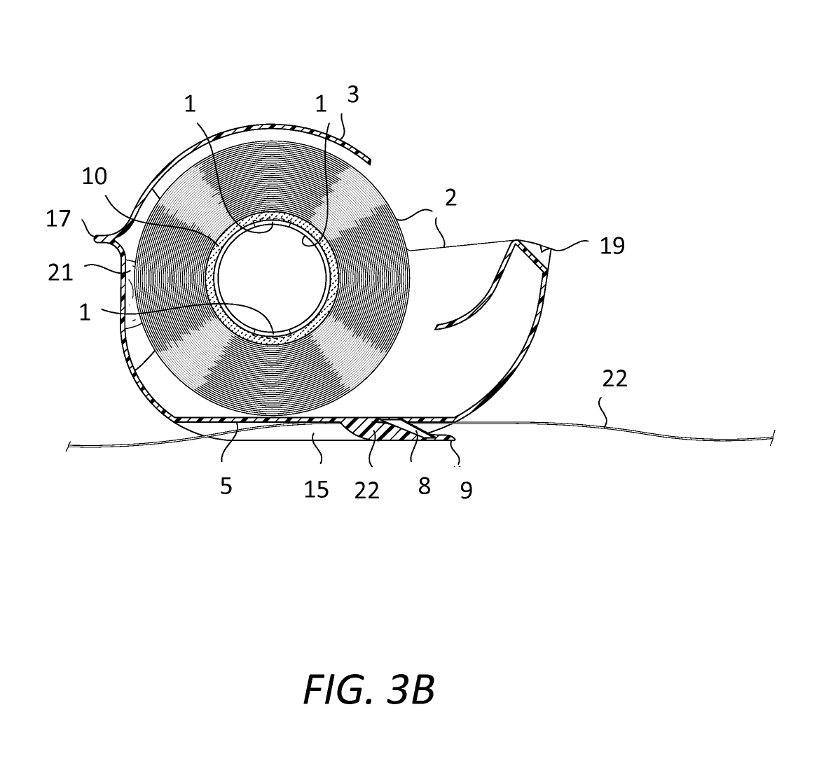

The device also includes a slide cutter 6. The slide cutter includes a small opening 7 in the substantially flat portion 5 of the outer wall 4. A blade 8 is located in the opening. The blade 8 may be a thin, sharp blade such as a razor blade, utility knife blade, or scalpel blade. In some embodiments, the edge of the blade 8 forms an acute angle with the substantially flat portion 5 of the outer wall. As shown in FIG. 3B, the blade 8 may be embedded in a housing 23. The housing 23 may have a proximal end located inside of the small opening. The housing 23 may have a distal end located outside of the small opening. In some embodiments, the housing extends out of the opening. The housing 23 may be fused with the edge of the opening towards which the edge of the blade is not facing. In some embodiments, the slide cutter 6 also includes a guiding lip 9. The guiding lip 9 may be at the distal end of the blade 8. The guiding lip 9 may be at the distal end of the housing 23. In some embodiments, the guiding lip caps the distal end of the blade 8, so that the end of the blade 8 is not exposed. In one embodiment the distal end of the housing 23 is attached to the guiding lip 9. In another embodiment, the distal end of the housing 23 is fused to the guiding lip 9. In still another embodiment, the guiding lip 9 and the housing 23 form a single, monolithic unit. The guiding lip 9 may be substantially parallel to the substantially flat portion 5 of the outer wall 4. In some embodiments, the bottom 12 of the device includes a curved portion that curves upward toward the front 14 of the device, and the guiding lip protrudes beyond the curvature of the curved portion. In some embodiments, where the slide cutter 6 is located on the bottom 12 of the device, the underside of the guiding lip 9 is substantially flat. The tip of the guiding lip 9 may be pointed in some embodiments, so that the guiding lip 9 may be slipped into an envelope and the slide cutter 6 used as a letter opener.

The serrated blade 19 for cutting lengths of tape 2 and the paper-cutting blade 9 can be made of any material known to persons of ordinary skill in the art as suitable for creating serrated and straight cutting edges, including without limitation glass and other crystalline materials, ceramics, plastics, and metals. Any methods of fabrication known to be suitable for the production of the tape dispenser body, blades, and paper-cutting apparatus may be used to produce the disclosed invention.

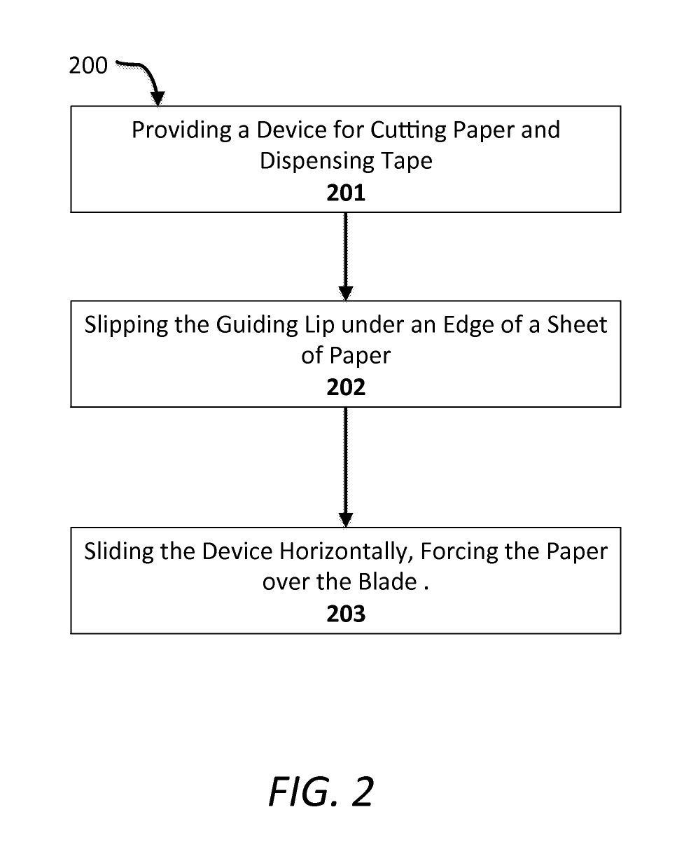

FIG. 2 illustrates a method for cutting paper. In brief overview, the method 200 involves providing a device as described above in reference to FIGS. 1A-1B (201). The method 200 involves slipping the guiding lip under an edge of a sheet of paper (202). The method further involves sliding the device horizontally, forcing the paper over the blade (203). FIG. 3A further illustrates the method. The guiding lip 9 is formed to slip under the edge of the paper 22. As illustrated by FIG. 3B, once the person operating the device begins pushing it across the paper, the guiding lip 9 and the angle of the blade 8 causes the paper 22 to ride up the edge of the blade 8. Because the blade 8 is sharp, the friction of the paper 22 across its edge causes the blade to cut into the paper 22.

In some embodiments, the method further includes folding the paper 22 around an object, dispensing tape 2 from the device, and using the dispensed tape 2 to secure the paper 22 as folded. Other embodiments include using the creasing fin 17 to crease folded paper. The creasing fin 17 may be used to flatten the tape against surfaces to which it adheres. The creasing fin 17 may be used to curl ribbons by using a thumb or hard surface to press a ribbon against the ridge while pulling the ribbon over the ridge. Another embodiment involves using the graduated demarcations 16 on the lower ridges to measure objects, including the dimensions of a gift to be wrapped and of the wrapping paper necessary completely to enfold that gift. The paper cutter may also be used to cut other paper and to open envelopes.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A device for cutting paper and dispensing tape, the device comprising:
a substantially cylindrical hub about which a roll of tape is rotably mounted;
at least one transverse wall fixed to a circular end of the hub;
an outer wall fixed to the transverse wall, having at least one substantially flat portion and forming, with the transverse wall and hub, a partially enclosed annular chamber for housing the roll of tape; and
a slide cutter comprising (i) a small opening in the substantially flat portion of the outer wall, (ii) a blade protruding from the small opening, the blade having a proximal end within the small opening, a distal end outside the small opening, and an edge, the edge forming an acute angle with the substantially flat portion, and (iii) a guiding lip at the distal end of the blade and substantially parallel to the substantially flat portion.

2. A device according to claim 1, further comprising two substantially parallel ridges extending from the substantially flat portion, the ridges forming a rectangular groove such that the slide cutter is within the rectangular groove.

3. A device according to claim 2, further comprising a set of graduated demarcations along at least one of the two ridges.

4. A device according to claim 1, further comprising a creasing fin fixed to the outer wall.

5. A device according to claim 1 wherein the guiding lip further comprises a pointed end.

6. A method for cutting paper, the method comprising:
providing a device according to claim 1;
slipping the guiding lip under an edge of a sheet of paper; and
sliding the device horizontally, forcing the paper over the blade.

7. A method according to claim 6, further comprising:
folding the paper around an object;
dispensing tape from the device; and
using the dispensed tape to secure the paper as folded.

8. A device for dispensing tape and cutting paper, the device comprising:
a body having a front end, a back end, a top, a bottom having a substantially flat portion, and at least one transverse wall;
a substantially cylindrical hub around which a roll of tape is rotably mounted, and having at least one circular end fixed to the at least one transverse wall, such that the hub, top, bottom, back end, and front end together form a partially open annular chamber enclosing the roll of tape; and
a slide cutter comprising (i) an opening in the substantially flat portion of the bottom, (ii) a housing, having a proximal end in inside of the small opening and a distal end outside of the small opening, a blade set in the housing, having an edge facing the front end of the device, the edge forming an acute angle with the plane of the substantially flat portion of the underside, and a guiding lip, fixed to the distal end of the housing, the guiding lip substantially parallel to the substantially flat portion of the underside and having an end that extends past the edge of the blade toward the front end.

9. A device according to claim 8, wherein the bottom further comprises a curved portion that curves upward from the substantially flat portion, and the guiding lip protrudes beyond the curvature of the curved portion.

10. A device according to claim 8, wherein the underside of the guiding lip is substantially flat.

11. A device according to claim 8, wherein the underside further comprises two parallel ridges running from the front end to the back end on opposite sites of the substantially flat portion and forming a rectangular groove that contains the slide cutter.

12. A device according to claim 8, wherein the annular chamber extends away from the hub toward the front end to form a hollow arm that bears a serrated edge for cutting lengths of dispensed tape.

13. A device according to claim 12, wherein the hollow arm further comprises a flat section behind the serrated edge, for adhering the end of the tape.

14. A device according to claim 8, further comprising at least one ergonomic indentation in the at least one transverse wall.
